(19) United States
(12) Patent Application Publication
(10) Pub. No.: US 2008/0061991 A1
(43) Pub. Date: Mar. 13, 2008

(54) System and method for remote Audio/Video capture of weapon use

(76) Inventors: Randall Lee Urban, Louisburg, KS (US); Laura Ellen Owen, Olathe, KS (US); John Andrew Drakey, Overland Park, KS (US)

Correspondence Address: LADI O. SHOGBAMIMU, 2106 W. 121ST STREET, LEAWOOD, KS, 66209, US

(21) Appl. No.: 11/852,328

(22) Filed: Sep. 10, 2007

Related U.S. Application Data
(60) Provisional application No. 60/825,144, filed on Sep. 11, 2006.

(51) Int. Cl. G08B 21/00; H04N 5/91

(52) U.S. Cl. 340/573.1; 386/107; 386/E05.061

(57) ABSTRACT

The present invention is directed to a system and method for activating a remote audio/visual device to monitor, capture and record the activities and conditions encountered by a law enforcement official when a weapon or other tool is removed from its retention device.

This application claims the benefit for U.S. Provisional Patent Application Ser. No. 60/825,144, filed Sep. 11, 2006; the disclosure of which is incorporated herein by reference in its entirety.

The present invention is directed to a system and method for remotely monitoring and/or capturing audio/visual or other sensory data associated with activities and conditions encountered at a scene by a law enforcement officer.

### BACKGROUND OF THE INVENTION

Security issues, personnel safety, controversial situations and other motivations for surveillance, continue to drive wide scale deployment of systems that can provide monitoring and data capture for a wide variety of events or situations. The integrity of such captured data is also crucial from an evidentiary standpoint. In some of these systems it is necessary to transmit acquired information to a remote station, a central monitoring location or to other devices. It is also the case that in some situations, it would be advantageous to have the ability to provide automated triggering of such remote monitoring. In other words, there exists a need for a system and method that minimizes the potential for human error and eliminates the need for direct human intervention when the capture of information would be of vital importance.

Some of the problems currently faced by law enforcement personnel include how to gather accurate, reliable information during an event or situation, particularly when such matters may be highly controversial. It is undisputed that the collection of relevant information would greatly facilitate the job of providing public safety, the safety of personnel and eventually serve the pursuit of justice with respect to most activities that are encountered by law enforcement officers.

It is necessary and in fact mandatory that any information which may ultimately be utilized as evidence be properly acquired, preserved and maintained. There has been a myriad of controversy surrounding activities and actions by law enforcement in the handling of evidence or suspects during the performance of their duties. Questions of procedure, the appropriateness of force that was utilized, and eye witness accounts of an event, continue to plaque law enforcement departments throughout the country. A suspect's version or other eyewitness accounts, of a given situation typically contradict the account provided by the law enforcement official. This creates a dilemma for the trier of fact in any criminal or investigative proceeding. The state or other prosecutorial body also has a burden to establish a credible case against an accused perpetrator. When the outcome of a proceeding relies upon human recollection and testimony regarding a situation i.e. testimony by witnesses, law enforcement officers who were present at the scene and the suspect, there is ample opportunity for mistakes or error in judgment by the triers of fact i.e. a judge or jury. Either of these fact triers must assume that one account of the event is more credible than another and as such decide accordingly.

One particular area of great contention relates to the use of weapons by officers, particularly because the outcome of such use is often fatal. To address this and other such issues, multimedia devices including Audio/Visual (A/V) equipment, have been rapidly introduced and utilized by various law enforcement agencies in an attempt to capture the events of situations that involve their officers.

Beyond the evidentiary and testimonial issues discussed above, another area of need and concern is the issue of officer safety. In some situations an officer may not be in a position to summon backup or it may be necessary for other officers at a scene to quickly assess the immediate environment of an officer who may be on a foot chase.

Presently, there have been various efforts made to provide alarm devices that are activated upon the withdrawal of a weapon by an officer. Such alarms are intended to aide a backup officer in locating and identifying another officer. Other existing devices activate a radio transmitter to signal that an officer's weapon has been removed from a holster. Some of these devices record and transmit audio data from the vicinity of the officer to a remote base station. Such devices are primarily used for wire tapping surveillance purposes. One such device is described in U.S. Pat. No. 4,936,037 ‘Pistol with concealed radio transmitter’. Other devices provide for the recording of audio data, on a recorder worn by the officer, when a weapon is withdrawn from the holster. Such a device is described in U.S. Pat. No. 5,479,149 ‘Weapon Use Monitoring and Recording System’. None the less, these devices and prior art, separately or in the aggregate, do not disclose or teach activation of a remotely located audio/visual recorder. These devices further do not resolve the issues of video capture nor do they provide the ability to record such surveillance information to a remote device. Importantly, prior art devices do not provide solutions that enable the recording and thus later review of all events and activities (‘total picture’) leading up to and including the discharge or use of a weapon. Video provides a clear and more precise depiction of a scene. Even further, the disclosed devices do not address the triggering of audio/visual recording when a gun safety or other device lock is released. Further still, the prior art systems do not address the monitoring or capture of other sensory or environmental data that is present within the vicinity of the law enforcement officer. Such additional information may be crucial to an objective assessment of the scene and a determination of the safest strategic course of action.

### BRIEF SUMMARY OF THE INVENTION

The present invention is generally directed to a system and method for providing data capture of environmental conditions particularly audio/visual data, in connection with the withdrawal or use of a weapon by a law enforcement officer.

In one aspect, the present invention is directed to a system having a sensor adapted to provide a signal upon the withdrawal or removal of a weapon from a holster or other weapon retaining apparatus. The signal is wirelessly utilized to activate a remote camera or other audio/visual capturing device thereby enabling the capture of sound and video data originating in the vicinity of a law enforcement officer for simultaneous recording, storage or subsequent transmission.

In another aspect, the present invention is directed to a system as described in the first aspect, in which audio/visual data items are wirelessly transmitted to a remotely located multimedia storage device from portable input devices worn by the law enforcement officer.

In a further aspect, the present invention is directed to a system as described herein, wherein one or more sensors of other environmental conditions provide data to the remotely located multimedia device. Such other environmental data include temperature, chemical levels, etc.

In an even further aspect, the present invention is directed to a system as described in the first aspect, wherein the weapon withdrawal signal also activates the monitoring/sensing of other non audio/visual data that pertains to the immediate environment of the law enforcement officer.

In a further aspect the present invention is directed to providing data capture or activation signals upon the release of a gun safety or other weapon safety mechanism.

### BRIEF DESCRIPTION OF THE DRAWINGS

The present invention is further described with reference to the accompanying drawings, which show a particular construction of the present invention. However, it should be noted that the invention as disclosed in the accompanying drawings is illustrated for the purpose of explanation only. The various elements and combinations of elements described below and illustrated in the drawings can be arranged and organized differently to result in constructions which are still within the spirit and scope of the present invention.

FIG. 1 illustrates a network environment in which the system and method of the present invention may be implemented;

FIG. 2 is block diagram illustration of an exemplary implementation of a sensory device for providing the activation signal of the present invention; and

FIG. 3 is a block diagram illustrating local capture of audio/visual data and transmittal of same to a remote recording device.

### DETAILED DESCRIPTION OF INVENTION

The present invention is directed to a system and method for remotely monitoring and/or capturing audio/visual or other sensory data associated with activities and conditions of a scene at which a law enforcement officer is present.

Generally, the present invention provides an apparatus and method that comprises a sensing means to detect the removal of a gun or other weapons or tools from a holster or other retaining device. The removal of the weapon further resulting in the capture and storage of audio/visual data from the scene. More specifically, in an embodiment of the present invention, a wireless transceiver located on or about the retaining device or the officer provides a signal to activate a multimedia capture or storage device. Such multimedia capture and/or storage device includes and is not limited to an audio/video camera, a camera and a microphone in operative communication with a computing device for storage, such as a personal/laptop computer, personal digital assistant (PDA) or other hand-held device, or a server. The term audio/video camera as used herein is exemplary and is utilized interchangeably herein to mean any one or more combinations of the multi-media capture and/or storage device. A multi-media device may be located in a patrol car or other base station within the communication radius of a transceiver. The transceiver is located on or about the weapon retention device and provides wireless communication signals to the multi-media device. The wireless signals may originate from the sensing means or from a separate external wireless communications device that has a physical or other link to the sensing means. Upon receiving an indicia that a weapon has been removed from the rention device, the multi-media device initiates any number of actions, which are specified by prior configuration, programming or input. Such actions include starting a recording session, initiating a call to a base station and so on.

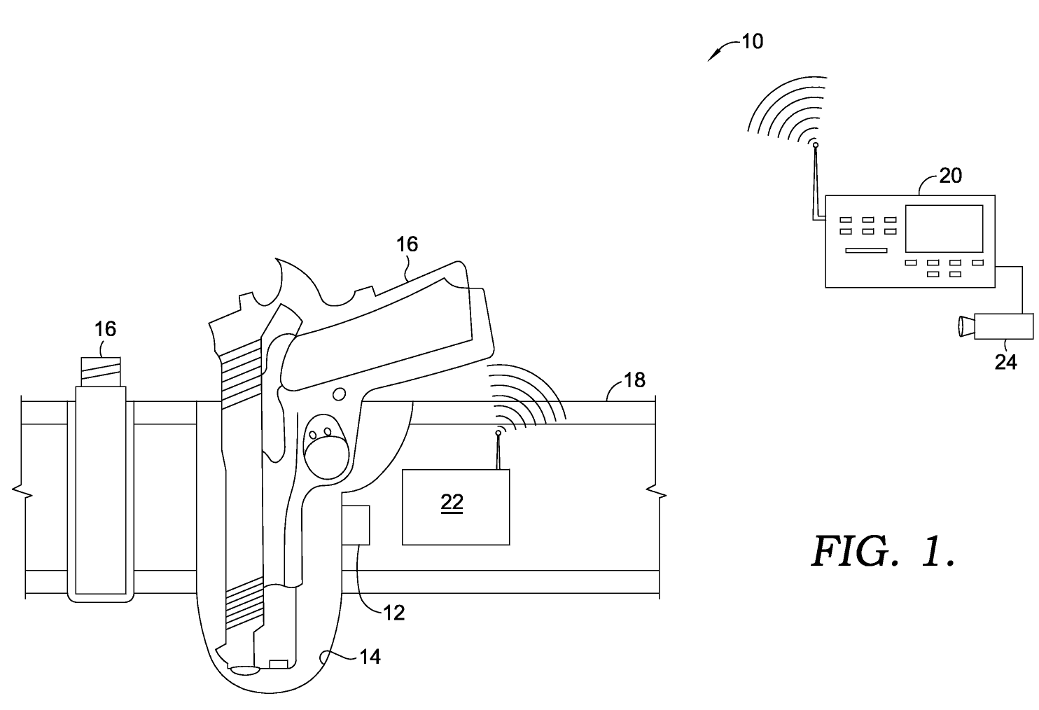

An exemplary architecture of an environment for the implementation of the remote activation of multi-media capture and storage of the present invention is illustrated in FIG. 1, and is generally designated as network 10. As shown, the network 10 includes one or more multimedia recording devices such as an Audio/Visual (A/V) recorder device 20, which includes a camera 24 and optionally a microphone, and a receiver. The network also includes weapon(s) 16, sensing device 12, a holster 14 and a transceiver 22. As would be appreciated by one skilled in the art, the topology of network 10 including the use of certain components may be varied without departing from the scope of the invention, and such variations are contemplated by the present invention. For example, more than one sensing device 12 may be present and may communicate with one or more A/V recorders 20. The transceiver 22 may be separate device from the sensing device 12 as shown, or may be integrated therewith. Additionally, more than one A/V device 20 may be in simultaneous communication with the transceiver 22, thus allowing simultaneous video recordings by multiple A/V recorders 20.

In the exemplary network 10, as shown, the sensing device 12 may be operatively attached to a holster 14 or other compartment sheath for a weapon 16 or other tool that may be carried on a belt 18 worn by a law enforcement officer. Weapon 16 or tool as used herein includes but is not limited to devices such as hand guns, stun guns, pepper spray and batons. The sensing device 12 is adapted to provide detection of the withdrawal of the weapon 16 from the holster 14, by any one or more conventional methods known in the art. The sensing device 12 may also be adapted to detect the presence of the weapon 16 or tool in the holster 14 or sheath. More specifically, in one embodiment, a proximity sensor is located within the holster 14 or on the weapon 16 to provide a continuous presence signal, which would be disrupted if the weapons should be removed. In another embodiment, a position switch is located such that the removal of the weapon 16 would alter the state of the position. In either case, the sensing device 12 provides a corresponding signal to the transceiver 22, whereby a wireless communication to a remote A/V device 20 ensues. The receipt of a wireless signal from the transceiver 22 initiates the recording of both audio and video on the remote A/V devices 20. It should be understood that the wireless signal could also trigger the recording of other environmental elements and/or conditions, events or other actions, as provided by devices that are located in a patrol car. Such actions may include initiating an alert signal from the patrol car to a base station to request backup.

When the weapon 16 is withdrawn, the remote A/V device 20 timestamps the event and begins to document events as they unfold. This allows supervisors to evaluate the circumstances of an incident for training purposes or the verification of facts in the event that a dispute should arise. Even further, activation of the A/V device 20 upon the withdrawal of the weapon allows for a record of events before during and after a weapon is discharged or otherwise utilized.

In another embodiment of the present invention, the sensing device 12 is activated and consequently the video recording that subsequently takes place is initiated, when the safety mechanism of a weapon is released, rather than just when the weapon 16 is withdrawn from the holster 14. Such a safety release event is more likely synonymous with the use of the weapon 16 than just the withdrawal from the holster 14.

In a further embodiment, the safety release event may also be used to identify another critical moment in a sequence of events that begins with the withdrawal of the weapon 16 and possibly the discharge of same.

In an even further embodiment of the present invention, the communication from the transceiver 22 to the A/V device 20 includes information about the relative position of the transceiver 22, i.e. the position of the law enforcement officer. The relative position information is then utilized t provide directional adjustments of the remote A/V device 20 to facilitate video coverage and tracking of the officer.

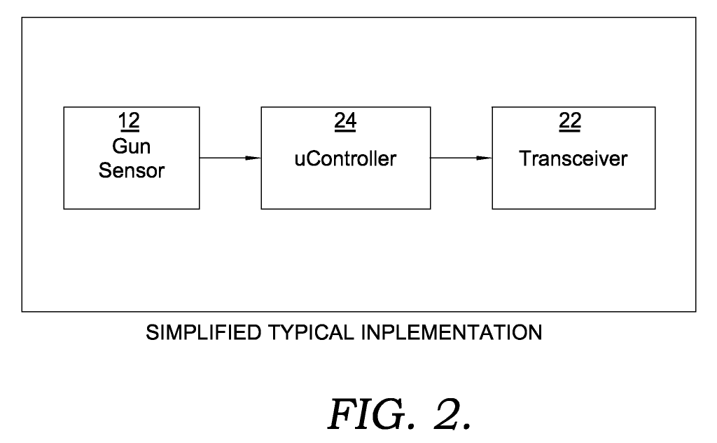

The operation of the sensing device 12 and the corresponding transmittal of a signal by the transceiver 22 is best described with reference to the drawing FIG. 2. FIG. 2 illustrates a block diagram of exemplary components for performing sensing and transmission functions described earlier. As shown, a sensing device 12 is operatively connected to a microprocessor 24 to enable logic processing as necessary. The microprocessor 24 initiates via the transceiver 22, a signal that is wirelessly communicated to the remote A/V device 20 (shown in FIG. 1). The receipt of the signal initiates video capture on the A/V device 20 and optionally the storage and/or subsequent transmission or display of the video.

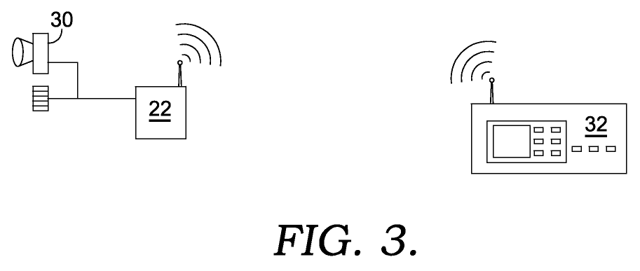

In another embodiment of the present invention, which is illustrated in FIG. 3, a local portable camera 30 having A/V capability is worn by a law enforcement officer. When a weapon 16 or tool is withdrawn from its holstered or retentive location, a signal is generated in a manner similar to that which was previously described. However, contrary to the previous description, the generated signal causes audio and video capture to begin on the portable camera 30. Video and audio data is then wirelessly transmitted to a remote Multimedia monitoring station and/or a recording device 32. The first receipt of a signal from the camera 30 is also utilized to signal the beginning of data transfer and create an initial timestamp.

The present invention resolves issues relating to video capture and the ability to record to a remote device, on-the-scene information associated with the use of a weapon. Furthermore, the present invention provides solutions that enable the recording and thus later review of all events and activities (i.e. ‘total picture’) leading up to and including the discharge or use of a weapon. Video data provided by the present invention provides a clear and more precise depiction of a scene. Even further, the present invention addresses, the triggering of audio/visual recording when a gun safety or other device lock is released. Further still, the present invention monitors and facilitates capture of sensory or environmental data that is present within the vicinity of the law enforcement officer who may be utilizing the withdrawn weapon.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This aspect is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

What is claimed is:

1. A system for monitoring and capturing audio-visual data in connection with the use of a weapon by a law enforcement officer, the system comprising:
a remote multi-media device having capture and recording means;
a weapon retention device;
a weapon, removedly located in said weapon retention device;
a sensing means proximate with said weapon retention device; and
a transceiver;
said sensing means in operable communication with said transceiver, to provide a signal to said transceiver when said weapon is removed from said weapon retention device;
said transceiver operably providing a wireless signal to said remote multi-media device;
said multi-media device adapted to initiate audio and video capture when said wireless signal is received.

2. The system of claim 1, further comprising means for providing location information, whereby location information may be transmitted by said portable transceiver to said remote audio-visual device for adjusting orientation of said multi-media device.

3. The system of claim 1, wherein said weapon is a hand held gun.

4. The system of claim 1, wherein said weapon is a stun gun.

5. The system of claim 1, wherein said weapon is a pressurized spray canister.

6. The system of claim 1 wherein said weapon is a baton.

7. The system of claim 1 wherein said remote audio-visual device is located in a patrol car in the proximity of the law enforcement officer.

8. A system for remotely monitoring and capturing audio-visual data in connection with the use of a weapon by a law enforcement officer, the system comprising:
a remote multimedia storage device;
a holster supported on the law enforcement officer;
a weapon removedly located in said holster;
a sensing means located proximate said holster;
an audio-visual capture device in operable communication with said sensing means;
a data storage device; and
a transceiver coupled to said audio-visual capture device, and operable to communicate data from said audio-visual capture device to said remote multimedia storage device;
said sensing means operable to provide a signal to said audio-visual device to initiate sound and video capture;
wherein said portable audio-visual device provides audio-visual data to said transceiver.

9. The system of claim 8, wherein said sensing means is located proximate said holster to detect withdrawal of said weapon and is operable to generate said signal in connection therewith.

10. The system of claim 8, wherein said sensing means is located on said weapon to detect use of said weapon, and is operable to generate said signal in connection therewith.

11. The system of claim 8 further comprising an environmental sensor, said environmental sensor operable to provide data to said remote multimedia device for recording via said transceiver.

12. The system of claim 11, wherein said environmental sensor is a temperature sensor.

13. The system of claim 11, wherein said environmental sensor is a gas sensor.

14. A system for remotely monitoring and capturing audio-visual data in connection with the use of a weapon by a law enforcement officer, the system comprising:
a holster;
a weapon, removedly located in said holster;
a motion sensor;
a transceiver; and
a remote audio-visual device having capture and recording means;
said motion sensor located to detect removal of said weapon, and in operable communication with said transceiver to provide a first signal when said weapon is removed from said holster; said transceiver transmitting a second signal to said remote audio-visual device, whereby said remote audio-visual device starts capturing and recording audio-visual data.

15. The system of claim 14 further comprising:
a safety mechanism on said weapon; and
a second sensor operable to detect disengagement of said safety mechanism, and providing a second signal to said remote-audio visual device.
